(19) United States
(12) Patent Application Publication
(10) Pub. No.: US 2007/0095483 A1
(43) Pub. Date: May 3, 2007

(54) Film transfer apparatus

(75) Inventors: Andreas Krispin, Muhlheim (DE); Alexander Weber, Weinheim (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/528,929

(22) Filed: Sep. 28, 2006

(30) Foreign Application Priority Data
Sep. 29, 2005 (DE) 10 2005 046 687.7

(51) Int. Cl. B32B 37/12; B41F 23/08; B44C 1/17

(52) U.S. Cl. 156/540; 156/578; 156/234; 156/241

(57) ABSTRACT

A print finishing unit has an application system for applying an adhesive to some areas of a two-dimensional material, in particular sheet or web printing materials. The print finishing unit further has a transfer system for transferring a transfer layer, adhering to a carrier film by a release layer, under the action of pressure to the two-dimensional material, such that the transfer layer adheres to the two-dimensional material only in the areas coated with the adhesive. The print finishing unit also has a press cylinder and a transfer cylinder which form a common transfer nip. The application system has a further press nip with the press cylinder for the application of the adhesive to some areas of the two-dimensional material.

### BACKGROUND OF THE INVENTION

### Field of the Invention

The present invention relates to a film transfer apparatus for transferring a transfer layer, adhering to a carrier film by a release layer, under the action of pressure to a two-dimensional material coated with an adhesive, at least in some areas. The film transfer apparatus has an application system for applying the adhesive to some areas of two-dimensional material, in particular sheet or web printing materials. The apparatus further has a transfer system for transferring the transfer layer, adhering to a carrier film by of a release layer, under the action of pressure to the two-dimensional material, in such a way that the transfer layer adheres to the two-dimensional material only in the areas coated with the adhesive. The film transfer apparatus has a press cylinder and a transfer cylinder which form a common transfer nip, a transfer film supply roll for storing the carrier film being provided before of the transfer nip, and a transfer film waste roll for winding up the carrier film being provided after the transfer nip.

The film transfer apparatus of the generic type are used in finishing printed products, for example in order to produce glossy effects. The machines may be subdivided into hot embossing film machines and cold film transfer apparatus. In the latter, the transfer layer is transferred to the two-dimensional material only under pressure but not additionally under the action of heat. As a rule, the adhesive is printed in a cold film transfer apparatus having a printing unit which is disposed upstream of the transfer apparatus, so that a “printed image” of the adhesive remains on the two-dimensional material, to which the transfer layer adheres in the film transfer unit. Thanks to the high accuracy of the application of adhesive in the printing unit, for example extremely detailed metalization layers can be transferred to the two-dimensional material, for example in the form of texts. Other applications are films of any desired color, pre-embossed films and so on.

A problem in the film transfer technology is the relatively high amount of space required by the film transfer units.

### SUMMARY OF THE INVENTION

It is accordingly an object of the invention to provide a film transfer apparatus which overcomes the above-mentioned disadvantages of the prior art devices of this general type, which requires less space than the prior art.

With the foregoing and other objects in view there is provided, in accordance with the invention, a film transfer apparatus. The film transfer apparatus has an application system for applying adhesive to some areas of a two-dimensional material including sheet or web printing materials, and a transfer system disposed downstream of the application system and transferring a transfer layer, adhering to a carrier film by a release layer, under an action of pressure to the two-dimensional material. The transfer layer adheres to the two-dimensional material only in the areas coated with the adhesive. A press cylinder and a transfer cylinder together form a common transfer nip. A transfer film supply roll is provided for storing the carrier film being provided before the transfer nip. A transfer film waste roll is provided for winding up the carrier film being provided after the transfer nip. The transfer film supply roll and the transfer film waste roll are both disposed above the transfer system or the application system and placed in relation to each other such that maximum circumferences of the transfer film supply roll and the transfer film waste roll overlap each other.

The film transfer apparatus according to the invention is characterized by the fact that both the transfer film supply roll and the transfer film waste roll are both disposed above the same unit, in this case the transfer system or the application system. Here, they are to be placed in relation to one another in such a way that the maximum circumferences of the transfer film supply roll and the transfer film waste roll overlap. In this way, the space required for the corresponding supply rolls and waste rolls can be minimized. Here, the transfer system is to be understood to mean a unit of the film transfer apparatus in which a transfer layer to be transferred is transferred from a carrier film to a two-dimensional material, that is to say a substrate. Here, the application system is a system in which an adhesive is transferred to the substrate, that is to say to the two-dimensional material. The adhesive can particularly preferably be applied to some regions of the two-dimensional material by a printing form.

In an advantageous embodiment, provision is made for the transfer film supply roll and the transfer film waste roll to be disposed one above the other. In this way, in particular the lateral extent of the system containing the transfer film supply roll and transfer film waste roll is reduced. In addition, in this way the occurrence of forces which would act laterally on the system can also be reduced, that is to say torsional forces which would act on the transfer system or the application system, can be reduced.

In a further advantageous embodiment, provision is made for the transfer film supply roll and the transfer film waste roll to be rotatably mounted in the housing of the film transfer apparatus, above the transfer system and the application system. In this way, the need to install fixed connections between a supplementary module and the housing of the transfer system or the application system can be avoided.

In order to make it easier to retrofit a printing press to form a film transfer apparatus, provision is made for the carrier film to run on the outside of the housing. In this case, no regard has to be paid to arranging elements in the interior of the housing of a transfer system or an application system. In particular, it is simply possible to use a printing unit of a press in each case as a transfer system or application system.

In order to ensure safe working on and with the film transfer apparatus, provision is beneficially made for the carrier film to be covered by a pivotable upper and lower film guard. As a result of making pivoting possible, working on the carrier film can also be achieved while maintaining a certain amount of safety.

The application of different transfer layers, in particular different-colored transfer layers, to one and the same printing material, that is to say to the same two-dimensional material, can be achieved in an inventive development by a plurality of narrow-track supply rolls and/or film waste rolls in each case being disposed beside one another above the transfer system and/or the application system.

In an advantageous embodiment of the invention, in order to save used film, provision is made for a film buffer system or a film saving device to be provided between the transfer film supply roll and the transfer film waste roll. In this way, cycling of the film supply to the transfer nip can be made possible in a straightforward manner.

Therefore, acceleration processes of the transfer film supply roll and transfer film waste roll can advantageously be absorbed, so that uniform operation of the print finishing unit is possible.

The film saving device is advantageous since, typically, only some of the two-dimensional material is printed and in between the film web moving at the same speed has to run with it, so that the unused film material would be wasted. This can be prevented by an appropriate film saving device.

In a beneficial development, the print finishing unit according to the invention is distinguished by the fact that the application system has a press nip with the same press cylinder for the application of adhesive to some areas of the two-dimensional material. Therefore, a very compact construction of the print finishing unit is possible, merely because of the lack of a second press cylinder which would otherwise be assigned to the application system for the adhesive or to the transfer cylinder. As a result, the costs of such a print finishing unit can also be reduced. The application system for the adhesive is advantageously a printing unit, a varnishing unit or a modular coating system. Application systems of this type in presses are either present in any case in the case of a printing unit or are usual, at least in the case of a varnishing unit or modular coating system (also known as an MCS), so that an appropriate application system can be reconfigured without great expenditure to form an application system for adhesive.

In a further advantageous development of the apparatus according to the invention, the transfer cylinder and/or application cylinder are configured so that they can be thrown off the press cylinder. As a result, the print finishing unit which is part of the press can be turned on or turned off as needed. If required, with the transfer cylinder thrown off and the print finishing unit turned off, the application system can nevertheless be used for other purposes, for example for applying normal printing ink, varnish, special inks or for other finishing processes.

Other features which are considered as characteristic for the invention are set forth in the appended claims.

Although the invention is illustrated and described herein as embodied in a film transfer apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, sectional view through a supply roll and a waste roll disposed beside each other above a transfer system of a print finishing unit according to the invention;

FIG. 1B is a diagrammatic, sectional view through a film supply roll and a film waste roll disposed one above the other;

FIG. 1C is a diagrammatic, sectional view through the film supply roll and the film waste roll disposed one above the other above an application system;

FIG. 1D is a diagrammatic, sectional view through the film supply roll and the film waste roll disposed one above the other above a common unit containing the transfer system and application system; and

FIG. 2 is a diagrammatic, enlarged sectional view, not to scale, through the film transfer according to FIG. 1D.

### DESCRIPTION OF THE PREFERRED EMBODIMENTS

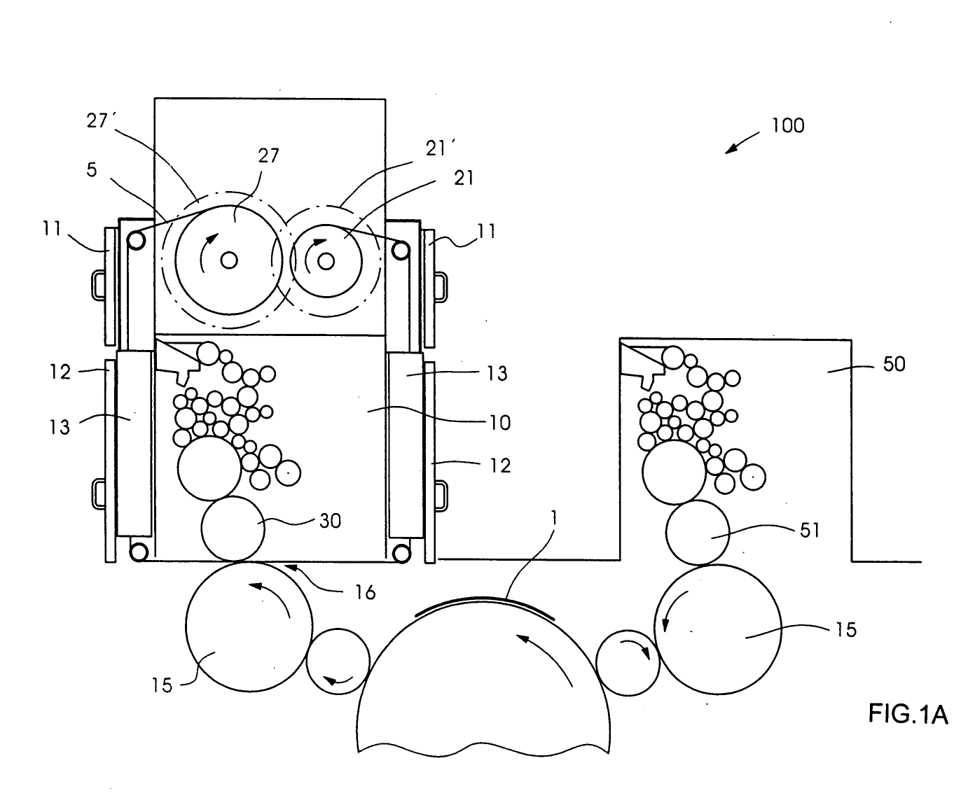

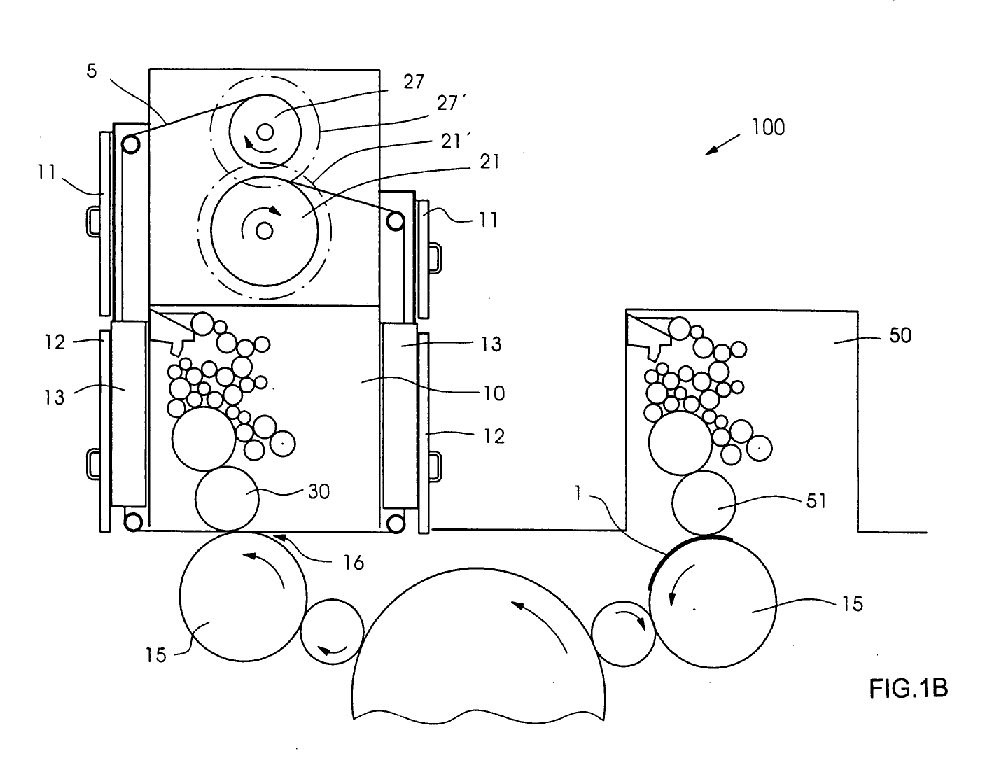

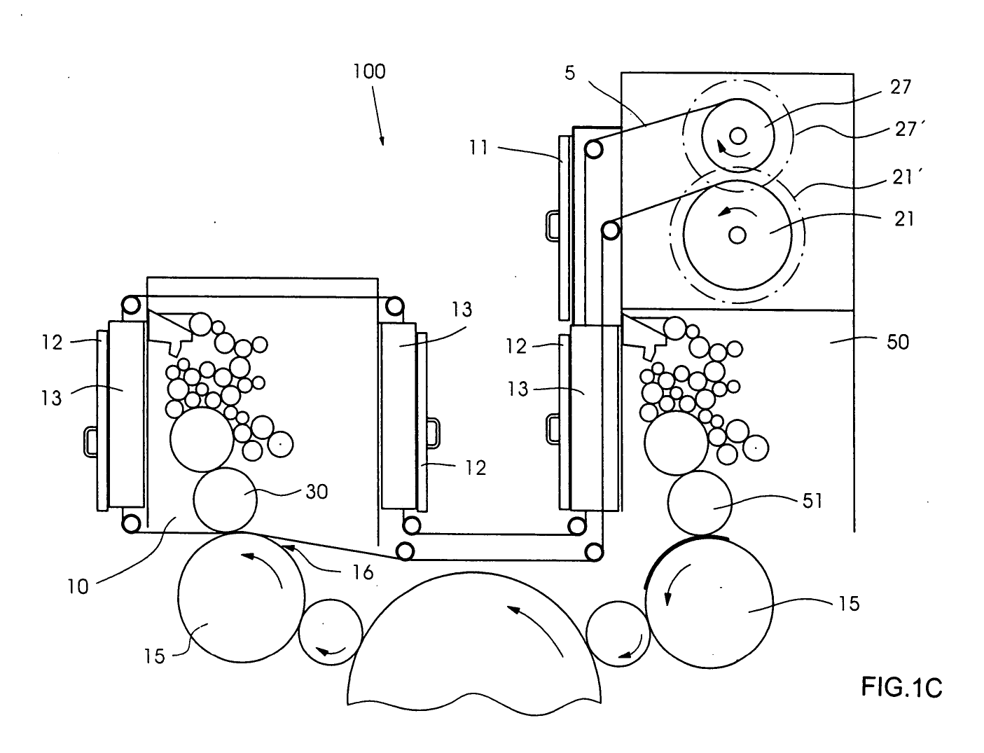

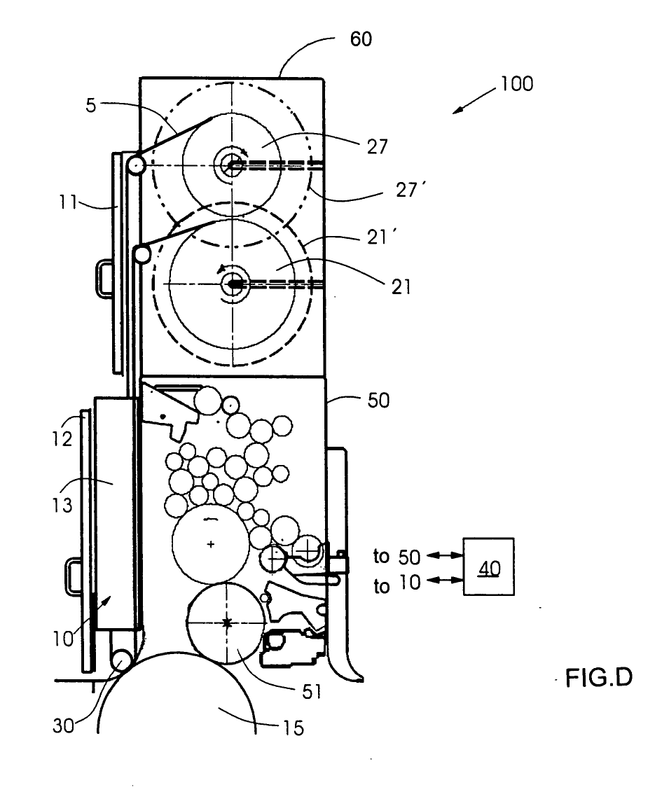

Referring now to the figures of the drawing in detail and first, particularly, to FIGS. 1A-1D thereof, there is shown illustrated schematically a print finishing unit 100 according to the invention. Further elements necessary for operation, such as mounting, drives, control and so on, which are not relevant to the invention are shown only schematically or not shown at all, since they are obvious to those skilled in the art and would merely hinder the understanding of the invention.

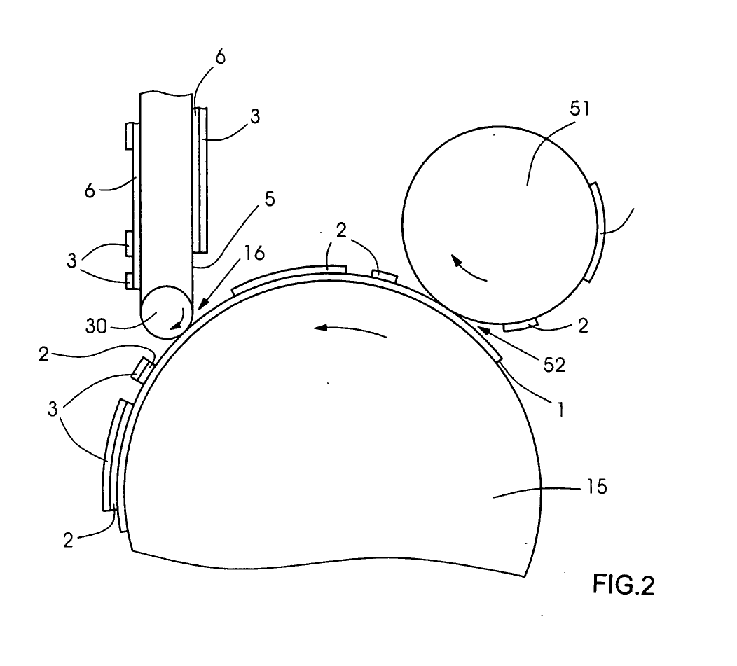

As shown in detail but not to scale in FIG. 2, in an application system 50, adhesive 2 is printed onto a two-dimensional material 1 in accordance with an image by an application cylinder 51, which rotates in a direction of rotation identified by the arrow. As compared with the thickness of the printing material 1 and a diameter of the cylinder 15, the two-dimensional material 1, the adhesive layer 2 and a transfer layer 3 on the two-dimensional material 1 are very thin. The transfer layer 3, which was previously connected to a carrier film 5 via a release layer 6, now adheres to the adhesive layer 2 applied in accordance with an image. The layer structure of the carrier film 5, the release layer 6 and the transfer layer 3 is shown by way of example but not to scale before and after the transfer cylinder. The carrier film 5 is connected over its entire area and its entire length with an appropriate release layer 6 and the transfer layer 3. Depending on the transfer, the transfer layer 3 is missing in the transferred regions.

The application cylinder 51 belongs to an application system 50, for example a normal printing unit of a press, for example a sheet-processing offset press. However, it is clear that the invention also finds application in web-processing presses. As an alternative to a conventional printing unit 15, a varnishing unit 50 or a modular coating system 50 (MCS) could also be involved. The application system 50 sets up an inverse adhesive image on the application cylinder 51, in a manner similar to that in conventional offset printing. To this end, the application system 50 is activated by a control system 40 (FIG. 1D), which is likewise connected to a transfer system 10 and controls the latter and also advantageously to a higher-order control system of the press.

Above the application system 50, a film supply roll 21 and the film waste roll 27 are disposed one above the other and rotatably mounted in the housing. Incidentally, a plurality [symbol] film waste rolls 27 can also be disposed beside one another above the application system 50. In order to save space, as shown in FIGS. 1A-1D, the film supply roll 21 and the film waste roll 27 should be placed in relation to each other such that the maximum circumferences 21′, 27′ of the film supply roll 21 and the film waste roll 27 overlap. This is possible since it is certainly the case that only one of the rolls 21, 27 can be full. The film supply roll 21 and film waste roll 27 are driven by non-illustrated drives which are activated by the control system 40.

The film guidance of the transfer film 5 runs on an outside of a housing 60 but is covered by a pivotable upper and lower film guard 11, 12. In addition, a film box 13 is arranged between the film supply roll 21 and film waste roll 27. Arranged in the film box 13 are non-illustrated dancers which regulate the web tension. In addition, additional drives for the film 5 can be disposed in the film box 13, and also a film reservoir, with which the film 5 can also be moved independently of the movement of the film supply roll 21 and the film waste roll 27; also a saving device for the film 5, and sensors for monitoring the film surface and the film transfer and so on, and a lifting device for the transfer cylinder, in order that the film 5 can be thrown off the press cylinder 15.

While in particular the method according to FIG. 1D is described by FIG. 2, corresponding alternative embodiments of the apparatus according to the invention are illustrated in FIGS. 1A-1C. In principle, what was mentioned above applies in the same way as to FIG. 2; as distinct from FIG. 2 and FIG. 1D, however, here the transfer system 10 and the application system 50 are in each case separated physically from each other and are present on different press cylinders 15. For example, the application system 50 can be a first printing unit of a press, and the transfer system 10 can be a second, following printing unit of a press. In this case, FIGS. 1A and 1B show embodiments in which both the transfer film supply roll 21 and the transfer film waste roll 27 are respectively arranged above the transfer system 10. In FIG. 1A the two film rolls 21 and 27 are arranged beside each other, and in FIG. 1B the two rolls 21, 27 are arranged one above the other above the transfer system 10. Here, the guidance of the carrier film 5 over appropriate guide rollers is constructed in such a way that the carrier film 5 is led through a transfer nip 16 in order to transfer the transfer layer 3. The transfer nip 16 is in this case formed by a transfer cylinder 30 and a press cylinder 15.

A further alternative embodiment is illustrated in FIG. 1C, the same as stated above also applying here. The two film rolls 21, 27 are disposed one above the other and, in the case illustrated here, are provided above the application system 50. Of course, an arrangement of the rolls beside each other would alternatively also be possible here. The carrier film 5 is led by appropriate guide rollers from the transfer film supply roll 21 to the transfer nip 16 and then by further guide rollers to the transfer film waste roll 27. For improved safety, by the appropriate upper and lower film guard 11, 12, the transfer film 5 is not led in the open. In order to increase safety, provision is additionally made here for the carrier film 5 to run, at least for some distance, underneath a region of the press which can be entered. It is thus possible to avoid uncontrolled contact with the carrier film 5 in moving operation.

By the embodiments outlined here, in each case a large requirement for space for the transfer film supply roll 21 and the transfer film waste roll 27 can be avoided. This is ensured first by the overlapping of the maximum circumferences of the transfer film supply roll 21 and the transfer film waste roll 27 and, to a particular extent, this applies to the arrangements as illustrated in FIGS. 1B, 1C and 1D, FIG. 1D illustrating a preferred case in which no supplementary application system 50 is needed physically separated from the unit in which the transfer of the transfer layer 3 is intended to take place.

This application claims the priority, under 35 U.S.C. §119, of German application DE 10 2005 046 687.7, filed Sep. 29, 2005; the prior application is herewith incorporated by reference in its entirety.

We claim:

1. A film transfer apparatus, comprising:
an application system for applying adhesive to some areas of a two-dimensional material including sheet or web printing materials;
a transfer system disposed downstream of said application system and transferring a transfer layer, adhering to a carrier film by a release layer, under an action of pressure to the two-dimensional material, the transfer layer adhering to the two-dimensional material only in the areas coated with the adhesive;
a press cylinder and a transfer cylinder together forming a common transfer nip;
a transfer film supply roll for storing the carrier film being provided before said transfer nip; and
a transfer film waste roll for winding up the carrier film being provided after said transfer nip, said transfer film supply roll and said transfer film waste roll being both disposed above said transfer system or said application system and placed in relation to each other such that maximum circumferences of said transfer film supply roll and said transfer film waste roll overlap each other.

2. The film transfer apparatus according to claim 1, wherein said transfer film supply roll and said transfer film waste roll are disposed one above another.

3. The film transfer apparatus according to claim 1, further comprising a housing, said transfer film supply roll and said transfer film waste roll are rotatably mounted in said housing, above said transfer system or said application system.

4. The film transfer apparatus according to claim 3, wherein said carrier film runs on an outside of said housing.

5. The film transfer apparatus according to claim 4, further comprising a pivotable upper and lower film guard covering said carrier film.

6. The film transfer apparatus according to claim 1, wherein said transfer film supply roll is formed of a plurality of narrow-track film supply rolls and said transfer film waste roll is formed of a plurality of narrow-track film waste rolls in each case disposed beside one another above said transfer system and/or said application system.

7. The film transfer apparatus according to claim 1, further comprising a film buffer system disposed between said transfer film supply roll and said transfer film waste roll.

8. The film transfer apparatus according to claim 1, further comprising a film saving device covering part of said carrier film.

9. The film transfer apparatus according to claim 1, wherein:
said transfer cylinder is part of said transfer system and forms said common transfer nip with said press cylinder; and
said application system having an application cylinder also forming a further press nip with said press cylinder for an application of the adhesive to some areas.

10. The film transfer apparatus according to claim 9, wherein said transfer cylinder and/or said application cylinder are configured such that they can be thrown off said press cylinder.

11. The film transfer apparatus according to claim 1, wherein said application system and/or said transfer system is selected from the group consisting of a printing unit, a varnishing unit and a modular coating system.
